(19) United States
(12) Patent Application Publication
(10) Pub. No.: US 2009/0208805 A1
(43) Pub. Date: Aug. 20, 2009

(54) MEMBRANE/ELECTRODE ASSEMBLY FOR POLYMER ELECTROLYTE FUEL CELL AND PROCESS FOR ITS PRODUCTION

(75) Inventors: Hirokazu WAKABAYASHI, Tokyo (JP); Hiroshi Shimoda, Tokyo (JP); Shinji Kinoshita, Tokyo (JP); Toshihiro Tanuma, Tokyo (JP); Hideki Nakagawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/370,983

(22) Filed: Feb. 13, 2009

(30) Foreign Application Priority Data
Feb. 15, 2008 (JP) 2008-034625

(51) Int. Cl. H01M 8/10; B29C 65/00; B05D 5/12; B32B 37/00

(52) U.S. Cl. 429/30; 156/60; 427/115; 156/278

(57) ABSTRACT

To provide a membrane/electrode assembly excellent in durability and capable of providing a high output voltage, and a process for its production.

A membrane/electrode assembly 10 for a polymer electrolyte fuel cell, comprising a polymer electrolyte membrane 12; a first frame 14 disposed at the periphery of a first surface of the polymer electrolyte membrane 12; a second frame 16 disposed at the periphery of a second surface of the polymer electrolyte membrane 12; a first electrode 22 having a first catalyst layer 18 and a first gas diffusion layer 20; and a second electrode 28 having a second catalyst layer 24 and a second gas diffusion layer 26; wherein the inner edge portion of the is first frame 14 is located between the first catalyst layer 18 and the first gas diffusion layer 20; and the inner edge portion of the second frame 16 is located between the polymer electrolyte membrane 12 and the second catalyst layer 24. In its production, the first catalyst layer 18 is formed by applying a coating fluid containing a catalyst and an ion exchange resin on the first surface of the polymer electrolyte membrane 12, and then, the first frame 14 is disposed at the periphery of the polymer electrolyte membrane 12.

### BACKGROUND OF THE INVENTION

1. Field of the Invention

The present invention relates to a membrane/electrode assembly for a polymer electrolyte fuel cell and a process for its production.

2. Discussion of Background

A polymer electrolyte fuel cell is constructed by stacking a plurality of membrane/electrode assemblies via an electrically conductive separator having gas flow paths formed thereon, wherein each membrane/electrode assembly has electrodes (a cathode (air electrode) and an anode (a fuel electrode)) bonded at the center portions on both sides of a polymer electrolyte membrane. Each electrode comprises a catalyst layer in contact with the polymer electrolyte membrane and a porous gas diffusion layer disposed at the outer side of the catalyst layer.

In the membrane/electrode assembly, no electrode is disposed at the periphery of the polymer electrolyte membrane, and thus, such a periphery is likely to be broken by the pressure difference between the cathode and the anode. As a membrane/electrode assembly having its periphery reinforced, a membrane/electrode assembly identified in the following (1) has been proposed.

(1) A membrane/electrode assembly wherein at the periphery of a polymer electrolyte membrane, a pair of frames are disposed to overlap with the electrodes (Patent Document 1).

However, in the membrane/electrode assembly (1), the electrodes and the polymer electrolyte membrane are bonded by a hot pressing method, whereby the adhesion between the catalyst layer and the polymer electrolyte membrane is inadequate. In an operation environment of the polymer electrolyte fuel cell, the polymer electrolyte membrane undergoes swelling in a wet state and shrinkage in a dry state repeatedly, and if the adhesion between the polymer electrolyte membrane and the catalyst layer is inadequate, due to the repeated swelling and shrinkage, the polymer electrolyte membrane is likely to be peeled from the catalyst layer, and the polymer electrolyte membrane is likely to be damaged. As a result, the durability of the membrane/electrode assembly tends to be inadequate.

As a membrane/electrode assembly excellent in the adhesion between the catalyst layer and the polymer electrolyte membrane, a membrane/electrode assembly having a catalyst layer formed by the following method (2) has been proposed.

(2) A method of forming a catalyst layer by applying a coating fluid containing a catalyst and an ion exchange resin on at least one surface of a polymer electrolyte membrane.

However, in a case where the membrane/electrode assembly (1) is produced by the method (2), it will be necessary to apply the coating fluid to both of the inner edge portion of the frame and the surface of the polymer electrolyte membrane, after disposing the frames at the periphery of the polymer electrolyte membrane, whereby a catalyst layer may not be well formed in the vicinity of the boundary between the inner edge portion of the frame and the polymer electrolyte membrane, and a portion composed solely of the membrane may be present between the inner edge portion of the frame and the portion where the catalyst layer is formed. As a result, as disclosed in e.g. Patent Document 2, the membrane is likely to deteriorate at the portion where the periphery of the catalyst layer is in contact with the membrane, whereby it is not possible to obtain high durability.

Patent Document 1: JP-A-05-021077

Patent Document 2: JP-A-2006-286478

### SUMMARY OF THE INVENTION

The present invention provides a membrane/electrode assembly for a polymer electrolyte fuel cell which is excellent in durability and which provides a high output voltage, and a process for its production.

The membrane/electrode assembly for a polymer electrolyte fuel cell of the present invention comprises a polymer electrolyte membrane containing an ion exchange resin; a first frame disposed at the periphery of the polymer electrolyte membrane so that at least a part thereof is in contact with a first surface of the polymer electrolyte membrane; a second frame disposed at the periphery of the polymer electrolyte membrane so that at least a part thereof is in contact with a second surface of the polymer electrolyte membrane; a first electrode having a first catalyst layer containing a catalyst and an ion exchange resin, and a first gas diffusion layer, wherein the first catalyst layer is in contact with the is first surface of the polymer electrolyte membrane; and a second electrode having a second catalyst layer containing a catalyst and an ion exchange resin, and a second gas diffusion layer, wherein the second catalyst layer is in contact with the second surface of the polymer electrolyte membrane; wherein the inner edge portion of the first frame is located between the first catalyst layer and the first gas diffusion layer; and the inner edge portion of the second frame is located between the polymer electrolyte membrane and the second catalyst layer.

The process for producing a membrane/electrode assembly for a polymer electrolyte fuel cell of the present invention is a process for producing the above-mentioned membrane/electrode assembly for a polymer electrolyte fuel cell and comprises forming the first catalyst layer on the first surface of the polymer electrolyte membrane by applying a coating fluid containing a catalyst and an ion exchange resin, and then disposing the first frame at the periphery of the polymer electrolyte membrane.

The process for producing a membrane/electrode assembly for a polymer electrolyte fuel cell of the present invention preferably comprises the following steps (b) to (d), (f) and (g):

(b) a step of forming the first catalyst layer by applying a coating fluid containing a catalyst and an ion is exchange resin on the first surface of the polymer electrolyte membrane;

(c) a step of bonding, at a stage after the step (b) the polymer electrolyte membrane and the first catalyst layer, and the first frame, so that at least a part of the first frame is in contact with the first surface of the polymer electrolyte membrane, and the inner edge portion of the first frame is in contact with the surface of the first catalyst layer;

(d) a step of bonding, at the same time as the step (c) or at a stage after the step (c), the first catalyst layer and the first frame, and the first gas diffusion layer, so that the first gas diffusion layer is in contact with the surface of the first catalyst layer and the inner edge portion of the first frame;

(f) a step of bonding, at a stage after the step (b), the polymer electrolyte membrane and the second frame, so that at least a part of the second frame is in contact with the second surface of the polymer electrolyte membrane; and

(g) a step of bonding, at the same time as the step (f) or at a stage after the step (f), the polymer electrolyte membrane and the second frame, and the second electrode, so that the surface of the second catalyst layer of the second electrode is in contact with the inner edge portion of the second frame and the second surface of the polymer electrolyte membrane.

The process for producing a membrane/electrode assembly for a polymer electrolyte fuel cell of the present invention preferably further includes the following steps (a) and (e):

(a) a step of forming the polymer electrolyte membrane by apply a coating fluid containing an ion exchange resin on the surface of a release substrate; and

(e) a step of peeling the release substrate from the second surface of the polymer electrolyte membrane at a stage after the step (b) and before the step (f).

In the above step (a), it is preferred to carry out anneal treatment at a temperature of from 100 to 250° C. after applying the coating fluid on the release substrate.

In the process for producing a membrane/electrode assembly for a polymer electrolyte fuel cell of the present invention, it is preferred that the steps (a), (b), (c), (d), (e), (f) and (g) are carried out in this order; or the steps (a) and (b) are carried out in this order, then the steps (c) and (d) are carried out simultaneously, then the step (e) is carried out, and then the steps (f) and (g) are carried out simultaneously.

The bonding in each of the steps (c), (d), (f) and (g) is preferably carried out by a hot pressing method.

The membrane/electrode assembly for a polymer electrolyte fuel cell of the present invention is excellent in durability and provides a high output voltage.

By the process for producing a membrane/electrode assembly for a polymer electrolyte fuel cell of the present invention, it is possible to produce a membrane/electrode assembly for a polymer electrolyte fuel cell which is excellent in durability and which provides a high output voltage.

### BRIEF DESCRIPTION OF THE DRAWINGS

FIG. 1 is a cross-sectional view illustrating an embodiment of the membrane/electrode assembly of the present invention.

FIG. 2 is a cross-sectional view illustrating another embodiment of the membrane/electrode assembly of the present invention.

FIG. 3 is a cross-sectional view illustrating another embodiment of the membrane/electrode assembly of the present invention.

FIG. 4 is a cross-sectional view illustrating another embodiment of the membrane/electrode assembly of the present invention.

FIG. 5 is a cross-sectional view illustrating another embodiment of the membrane/electrode assembly of the present invention.

FIG. 6 is a cross-sectional view illustrating another embodiment of the membrane/electrode assembly of the present invention.

FIG. 7 is a top view and a cross-sectional view illustrating the step (a) in the process for producing a membrane/electrode assembly of the present invention.

FIG. 8 is a top view and a cross-sectional view illustrating the step (b) in the process for producing a membrane/electrode assembly of the present invention.

FIG. 9 is a top view and a cross-sectional view illustrating the step (c) in the process for producing a membrane/electrode assembly of the present invention.

FIG. 10 is a top view and a cross-sectional view illustrating the step (d) in the process for producing a membrane/electrode assembly of the present invention.

FIG. 11 is a top view and a cross-sectional view illustrating the step (e) in the process for producing a membrane/electrode assembly of the present invention.

FIG. 12 is a top view and a cross-sectional view illustrating the step (f) in the process for producing a membrane/electrode assembly of the present invention.

FIG. 13 is a top view and a cross-sectional view illustrating the step (g) in the process for producing a membrane/electrode assembly of the present invention.

FIG. 14 is a cross-sectional view illustrating an embodiment of a polymer electrolyte fuel cell.

In the Figs., reference numeral 10 represents a membrane/electrode assembly, 12 a polymer electrolyte membrane, 14 a first frame, 16 a second frame, 18 a first catalyst layer, 20 a first gas diffusion layer, 22 a first electrode, 24 a second catalyst layer, 26 a second is gas diffusion layer, 28 a second electrode, 32 a membrane/electrode assembly, 34 a membrane/electrode assembly, 36 a membrane/electrode assembly, 38 a membrane/electrode assembly, 40 a membrane/electrode assembly, and 42 a release substrate.

### DETAILED DESCRIPTION OF THE PREFERRED EMBODIMENTS

In this specification, a compound represented by the formula (2) will be referred to as a compound (2). Compounds represented by other formulae will be likewise referred to.

### Membrane/Electrode Assembly

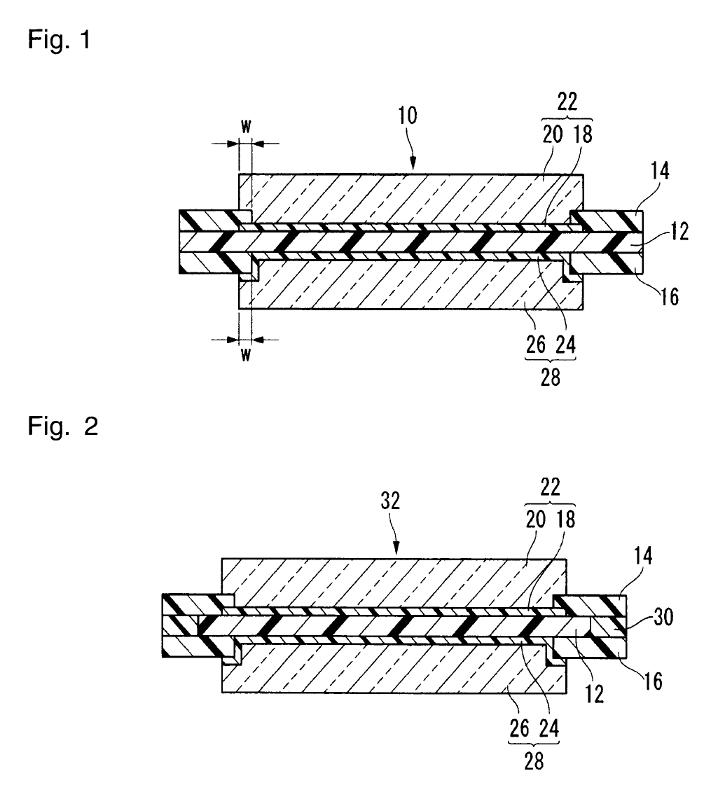

FIG. 1 is a schematic cross-sectional view illustrating an embodiment of the membrane/electrode assembly for a polymer electrolyte fuel cell of the present invention (hereinafter referred to as the membrane/electrode assembly). The membrane/electrode assembly 10 comprises a polymer electrolyte membrane 12, a first frame 14 disposed at the periphery of the polymer electrolyte membrane 12 so that it is in contact with one main surface (hereinafter referred to as the first surface) of the polymer electrolyte membrane 12, a second frame 16 disposed at the periphery of the polymer electrolyte membrane 12 so that it is in contact with the other main surface (hereinafter referred to as the second surface) of the polymer electrolyte membrane 12, a first electrode 22 having a first catalyst layer 18 and a first gas diffusion layer 20, wherein the first catalyst layer 18 is in contact with the first surface of the polymer electrolyte membrane 12, and a second electrode 28 having a second catalyst layer 24 and a second gas diffusion layer 26, wherein the second catalyst layer 24 is in contact with the second surface of the polymer electrolyte membrane 12.

The first electrode 22 and the second electrode 28 are disposed at the center portion of the polymer electrolyte membrane 12, to leave the periphery of the polymer electrolyte membrane 12 where no electrode is disposed.

The inner edge portion of the first frame 14 is located between the first catalyst layer 18 and the first gas diffusion layer 20.

The inner edge portion of the second frame 16 is located between the polymer electrolyte membrane 12 and the second catalyst layer 24.

The end edge on the outer edge portion side of the first frame 14 and the end edge on the outer edge portion side of the second frame 16 are flush with the end edge of the periphery of the polymer electrolyte membrane 12.

### Polymer Electrolyte Membrane

The polymer electrolyte membrane 12 is a membrane containing an ion exchange resin.

The ion exchange resin is preferably a fluororesin having ionic groups. The ionic groups may, for example, is be sulfonic acid groups or carboxylic acid groups.

The fluororesin having ionic groups is preferably a perfluorocarbon polymer having sulfonic acid groups (which may contain an etheric oxygen atom), particularly preferably a copolymer (hereinafter referred to as a copolymer (H)) having units based on tetrafluoroethylene (hereinafter referred to as TFE) and repeating units having sulfonic acid groups. The repeating units having sulfonic acid groups are preferably repeating units represented by the following formula (1).

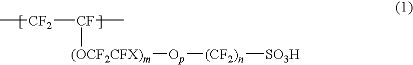

wherein X is a fluorine atom or a trifluoromethyl group, m is an integer of from 0 to 3, n is an integer of from 1 to 12, and p is 0 to 1.

The copolymer (H) is obtainable by polymerizing a mixture of TFE and a monomer having a —SO₂F group to obtain a copolymer (H′) and then converting —SO₂F groups in the copolymer (H′) to sulfonic acid groups. The conversion of —SO₂F groups to sulfonic acid groups is carried out by hydrolysis and treatment for acid-form.

The monomer having a —SO₂F group is preferably a compound (2).

CF_{2═CF(OCF}₂CFX)ₘ—Oₚ—(CF₂)—SO₂F (2)

wherein X is a fluorine atom or a trifluoromethyl group, m is an integer of from 0 to 3, n is an integer of from 1 to 12, and p is 0 or 1.

As the compound (2), compounds (2-1) to (2-3) are preferred.

CF₂═CFO(CF₂)_{q}—SO₂F (2-1)

CF₂═CFOCF₂CF(CF₃)O(CF₂)ᵣSO₂F (2-2)

CF₂═CF(OCF₂CF(CF₃))ₜO(CF₂)ₛSO₂F (2-3)

wherein each of q, r and s is an integer of from 1 to 8, and t is an integer of from 1 to 3.

The polymer electrolyte membrane 12 may contain a reinforcing material. The reinforcing material may, for example, be a porous body, fiber, woven fabric or non-woven fabric. The material for the reinforcing material may, for example, be a polytetrafluoroethylene (hereinafter referred to as PTFE), a tetrafluoroethylene/hexafluoropropylene copolymer, a tetrafluoroethylene/perfluoro(alkyl vinyl ether) copolymer, a polyethylene, a polypropylene or a polyphenylene sulfide.

The polymer electrolyte membrane 12 may contain an inhibitor to inhibit formation of a peroxide. When the polymer electrolyte membrane 12 contains such an inhibitor, it is possible to inhibit formation of a peroxide in a case where the membrane/electrode assembly 10 is used for a long time, whereby it is possible to suppress a decrease in the output due to deterioration of the polymer electrolyte membrane 12.

The thickness of the polymer electrolyte membrane 12 is preferably at most 50 μm, more preferably from 3 to 40 μm, particularly preferably from 5 to 30 μm. When the thickness of the polymer electrolyte membrane 12 is adjusted to be at most 50 μm, the polymer electrolyte membrane 12 may readily be made to be a dried state, whereby deterioration of the properties of the polymer electrolyte fuel cell can be suppressed. By adjusting the thickness of the polymer electrolyte membrane 12 to be at least 3 μm, short-circuiting may be avoided.

### Frames

Each of the first frame 14 and the second frame 16 (which may be hereinafter generally referred to as the frame) is a frame-shaped film and a reinforcing film to reinforce the periphery of the polymer electrolyte membrane 12 where no electrode is disposed, and it is a gas-shielding film to prevent leakage of a gas from the end edge at the periphery of the porous catalyst layer and a defining film to define the surface area of the catalyst layer.

The material for the frame may, for example, be a non-fluorinated resin (such as polyethylene terephthalate (hereinafter referred to as PET), polyethylene naphthalate (hereinafter referred to as PEN), polyethylene, polypropylene or polyimide), or a fluorinated resin (such as PTFE, an ethylene/tetrafluoroethylene copolymer (hereinafter referred to as ETFE), a tetrafluoroethylene/hexafluoropropylene copolymer, or a tetrafluoroethylene/perfluoro(alkyl vinyl ether) copolymer).

The thickness of the frame is preferably from 5 to 100 μm, more preferably from 10 to 100 μm. When the thickness of the frame is at least 5 μm, the gas shielding can sufficiently be carried out, and the strength of the polymer electrolyte membrane can be maintained. When the thickness of the frame is at most 100 μm, there will be no substantial influence of the overlapping of the gas diffusion layer and the frame over the structure when the membrane/electrode assemblies 10 are laminated and assembled into a stack.

The width W of the overlapping portion of the frame and the gas diffusion layer is preferably from 0.3 to 10 mm. When such a width W is at least 0.3 mm, a problem of cutting tolerance of the gas diffusion layer is less likely to result, and assembling by lamination and pressing can easily be carried out. On the other hand, even if such a width W is made larger than 10 mm, there is no particularly merit in the process, and therefore at most 10 mm is sufficient.

The first frame 14 is, at its inner edge portion, in contact with the first catalyst layer 18 and the first gas diffusion layer 20, and on the outer edge portion side than the inner edge portion, in contact with the first surface of the polymer electrolyte membrane 12. The inner edge portion of the first frame 14 being located between the first catalyst layer 18 and the first gas diffusion layer 20 means that the first frame 14 is disposed at the periphery of the polymer electrolyte membrane 12 after the first catalyst layer 18 is formed on the first surface of the polymer electrolyte membrane 12. Accordingly, if it is so designed that the inner edge portion of the first frame 14 is located between the first catalyst layer 18 and the first gas diffusion layer 20, it is possible to form the first catalyst layer 18 on the first surface of the polymer electrolyte membrane 12 by coating prior to disposing the first frame 14.

The second frame 16 is, at its inner edge portion, in contact with the second surface of the polymer electrolyte membrane 12 and the second catalyst layer 24 and on the outer edge portion side than the inner edge portion, in contact with only the second surface of the polymer electrolyte membrane 12.

The inner edge portion of the second frame 16 being located between the polymer electrolyte membrane 12 and the second catalyst layer 24 means that the second electrode 28 is bonded after disposing the second frame 16 at the periphery of the second surface of the polymer electrolyte membrane 12.

### Catalyst Layers

Each of the first catalyst layer 18 and the second catalyst layer 24 (which may generally be referred to as the catalyst layer) is a layer containing a catalyst and an ion exchange resin. The area of the catalyst layer is smaller than the area of the polymer electrolyte membrane 12.

The catalyst is preferably a supported catalyst having platinum or a platinum alloy supported on a carbon carrier.

The carbon carrier may, for example, be activated carbon or carbon black.

The specific surface area of the carbon carrier is preferably at least 200 m²/g. The specific surface area of the carbon carrier is measured by absorption of nitrogen on the carbon surface by a BET specific surface area measuring apparatus.

The platinum alloy is preferably an alloy of platinum with at least one metal selected from the group consisting of a metal of platinum group excluding platinum (such as ruthenium, rhodium, palladium, osmium or iridium), gold, silver, chromium, iron, titanium, manganese, cobalt, nickel, molybdenum, tungsten, aluminum, silicon, zinc and tin. Such a platinum alloy may contain an intermetallic compound of platinum with a metal to be alloyed with platinum.

The supported amount of platinum or a platinum alloy is preferably from 10 to 70 mass % based on the catalyst (100 mass %).

The ion exchange capacity of the ion exchange resin is is preferably from 0.5 to 2.0 meq/g dry resin, particularly preferably from 0.8 to 1.5 meq/g dry resin, from the viewpoint of the electrical conductivity and gas permeability.

The ion exchange resin is preferably the above-mentioned fluororesin having ionic groups, more preferably a perfluorocarbon polymer having sulfonic acid groups (which may contain an etheric oxygen atom), particularly preferably the copolymer (H), from the viewpoint of the durability.

The ratio of the catalyst to the ion exchange resin (catalyst/ion exchange resin) is preferably from 4/6 to 9.5/0.5 (mass ratio), particularly preferably from 6/4 to 8/2, from the viewpoint of the electrical conductivity and water repellency of the electrodes.

The amount of platinum contained in the catalyst layer is preferably from 0.01 to 0.5 mg/cm², more preferably from 0.05 to 0.35 mg/cm², from the viewpoint of the optimum thickness to efficiently carry out the electrode reaction.

The thickness of the catalyst layer is preferably at most 20 μm, more preferably from 1 to 15 μm, with a view to facilitating the gas diffusion in the catalyst layer and improving the characteristics of the polymer electrolyte fuel cell. Further, the thickness of the catalyst layer is preferably uniform. If the thickness of the catalyst layer is made thin, the amount of the is catalyst present per unit area becomes small, whereby the reaction activity is likely to be low. However, in such a case, a supported catalyst may be employed wherein platinum or a platinum alloy is supported as a catalyst in a high supported ratio, whereby even if the thickness of the catalyst layer is thin, the reaction activity of the electrodes can be maintained at a high level without deficiency in the amount of the catalyst.

Further, the catalyst layers of the anode and the cathode may be the same or different.

### Gas Diffusion Layers

Each of the first gas diffusion layer 20 and the second gas diffusion layer 26 (which may be hereinafter generally referred to as the gas diffusion layer) is a layer having a gas diffusing substrate. The area of the gas diffusion layer is the same or smaller than the area of the polymer electrolyte membrane 12.

The gas diffusing substrate is a porous substrate having electrical conductivity. The gas diffusing substrate may, for example, be carbon cloth, carbon paper or carbon felt.

The gas diffusing substrate is preferably treated for water repellency with e.g. PTFE or a mixture of PTFE with carbon black.

The thickness of the gas diffusion layer is preferably from 100 to 400 μm, more preferably from 140 to 350 μm. The gas diffusion layers may be the same or different in the anode and the cathode.

### Other Embodiments

The membrane/electrode assembly of the present invention is not limited to the membrane/electrode assembly 10 in FIG. 1.

As other embodiments, the following embodiments (1) to (5) may, for example, be mentioned.

(i) As shown in FIG. 2, a membrane/electrode assembly 32 wherein a spacer 30 is further provided so that it is in contact with the end edge of the periphery of the polymer electrolyte membrane 12, the spacer 30 is located between the outer edge portion of the first frame 14 and the outer edge portion of the second frame 16, and the end edge on the outer edge portion side of the spacer 30 is flush with the end edge on the outer edge portion side of the first frame 14 and the end edge on the outer edge portion side of the second frame 16.

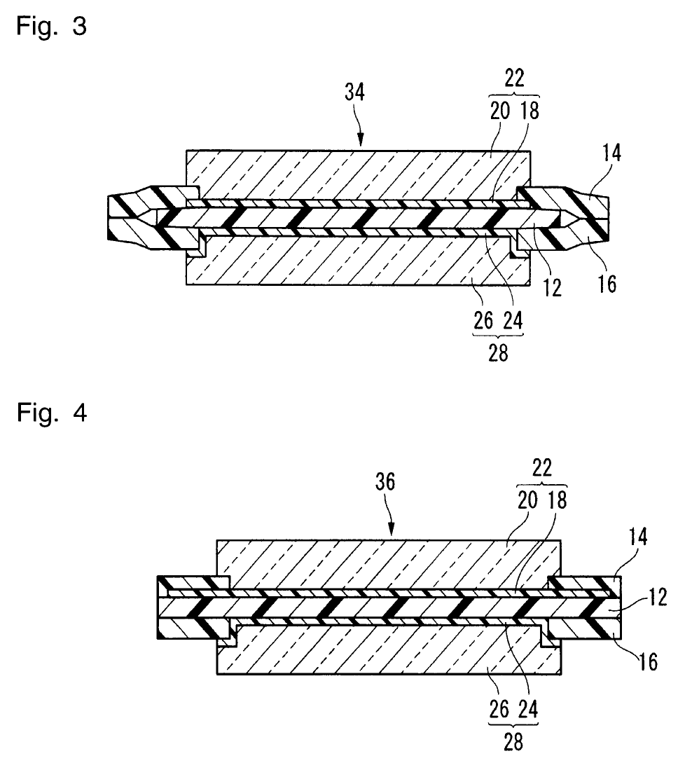

(ii) As shown in FIG. 3, a membrane/electrode assembly 34 wherein the outer edge portion of the first frame 14 and the outer edge portion of the second frame 16 are bonded.

(iii) As shown in FIG. 4, a membrane/electrode assembly 36 wherein the first catalyst layer 18 is made larger than the first gas diffusion layer 20, the second catalyst layer 24 and the second gas diffusion layer 26.

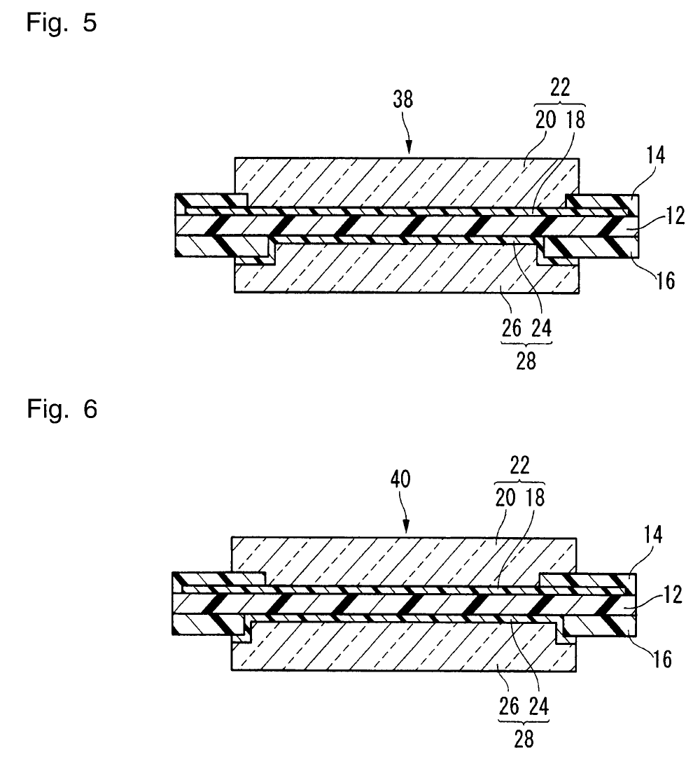

(iv) As shown in FIG. 5, a membrane/electrode assembly 38 wherein the first catalyst layer 18 is made larger than the first gas diffusion layer 20, the second catalyst layer 24 and the second gas diffusion layer 26, and the second frame 16 is made larger than the first frame 14.

(v) As shown in FIG. 6, a membrane/electrode assembly 40 wherein the first catalyst layer 18 is made larger than the first gas diffusion layer 20, the second catalyst layer 24 and the second gas diffusion layer 26, and the first frame 14 is made larger than the second frame 16.

Further, the electrode may have a carbon layer (not shown) between the catalyst layer and the gas diffusion layer. The carbon layer is a layer containing a carbon material and a binder resin.

The carbon material is preferably a carbon nano fiber having a fiber diameter of from 1 to 1,000 nm and a fiber length of from 1 to 1,000 μm.

The binder resin may, for example, be an ion exchange resin or a fluororesin (such as PTFE).

### Process for Producing Membrane/Electrode Assembly

The process for producing a membrane/electrode assembly of the present invention comprises forming the first catalyst layer on the first surface of the polymer electrolyte membrane by applying a coating fluid containing a catalyst and an ion exchange resin, and then disposing the first frame at the periphery of the polymer electrolyte membrane.

As a specific example of the process for producing a membrane/electrode assembly of the present invention, a process comprising the following steps (a) to (g) may be mentioned.

(a) A step of forming a polymer electrolyte membrane on the surface of a release substrate by applying a coating fluid containing an ion exchange resin.

(b) A step of forming a first catalyst layer on the first surface of the polymer electrolyte membrane by applying a coating fluid containing a catalyst and an ion exchange resin.

(c) A step of bonding, at a stage after the step (b), the polymer electrolyte membrane and the first catalyst layer, and the first frame, so that at least a part of the first frame is in contact with the first surface of the polymer electrolyte membrane, and the inner edge portion of the first frame is in contact with the surface of the first catalyst layer.

(d) A step of bonding, at the same time as the step (c) or at a stage after the step (c), the first catalyst layer and the first frame, and the first gas diffusion layer, so that the first gas diffusion layer is in contact with the surface of the first catalyst layer and the inner edge portion of the first frame.

(e) A step of peeling the release substrate from the second surface of the polymer electrolyte membrane at a stage after the step (b) and before the step (f).

(f) A step of bonding, at a stage after the step (b), the polymer electrolyte membrane and the second frame, so that at least a part of the second frame is in contact with the second surface of the polymer electrolyte membrane.

(g) A step of bonding, at the same time as the step (f) or at a stage after the step (f), the polymer electrolyte membrane and the second frame, and the second electrode, so that the surface of the second catalyst layer of the second electrode is in contact with the inner edge portion of the second frame and the second surface of the polymer electrolyte membrane.

As the process for producing a membrane/electrode assembly of the present invention, preferred is a process wherein the steps (a), (b), (c), (d), (e), (f) and (g) are carried out in this order, or a process wherein the steps (a) and (b) are carried out in this order, then the steps (c) and (d) are carried out simultaneously, then the step (e) is carried out, and then the steps (f) and (g) are carried out simultaneously, from such a viewpoint that the first catalyst layer is less likely to have wrinkles.

Now, the process for producing a membrane/electrode assembly 10 will be described with reference to the method wherein the steps (a) to (g) are carried out in this order.

### Step (a)

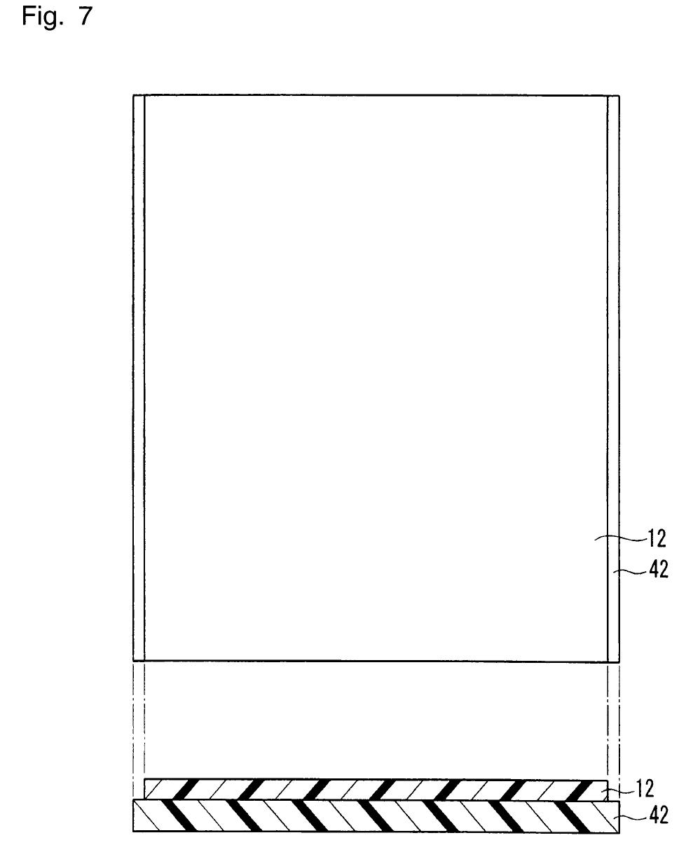

As shown in FIG. 7, a polymer electrolyte membrane 12 is formed on the surface of a release substrate 42 by applying a coating fluid containing an ion exchange resin (hereinafter referred to as a coating fluid for an electrolyte membrane).

Here, in a case where a commercially available polymer electrolyte membrane provided with a release substrate (e.g. FLEMION (registered trademark) manufactured by Asahi Glass Company, Limited) is used, the step (a) can be omitted.

As the release substrate 42, a resin film may be mentioned. The material for the resin film may, for example, be a non-fluorinated resin (such as PET, PEN, polyethylene, polypropylene or polyimide), or a fluorinated resin (such as PTFE, ETFE, an ethylene/hexafluoropropylene copolymer, a tetrafluoroethylene/perfluoro(alkyl vinyl ether) copolymer or a poly(vinylidene fluoride)).

The non-fluorinated resin film is preferably surface-treated with a release agent.

The coating fluid for an electrolyte membrane is prepared by dissolving or dispersing an ion exchange resin in a solvent. The solid content concentration in the coating fluid for an electrolyte membrane is preferably from 15 to 30 mass %, more preferably from 20 to 30 mass %. When the solid content concentration in the coating fluid for an electrolyte membrane is within such is a range, the coating fluid for an electrolyte membrane has a proper viscosity and can be uniformly applied, and no cracking will be formed in the polymer electrolyte membrane 12 thereby formed.

In a case where the ion exchange resin is a fluorinated resin having ionic groups, the solvent is preferably an alcohol or a fluorinated solvent.

The alcohol may, for example, be ethanol, n-propanol, isopropanol, n-butanol, isobutanol or tert-butanol. In order to increase the solubility of the ion exchange resin, a mixed solvent of an alcohol with water may be employed.

As the fluorinated solvent, the following ones may be mentioned.

Hydrofluorocarbons: 2H-Perfluoropropane, 1H,4H-perfluorobutane, 2H,3H-perfluoropentane, 3H,4H-perfluoro(2-methylpentane), 2H,5H-perfluorohexane, 3H-perfluoro(2-methylpentane), etc.

Fluorocarbons: Perfluoro(1,2-dimethylcyclobutane) perfluorooctane, perfluoroheptane, perfluorohexane, etc.

Hydrochlorofluorocarbons: 1,1-Dichloro-1-fluoroethane, 1,1,1-trifluoro-2,2-dichloroethane, 3,3-dichloro-1,1,1,2,2-pentafluoropropane, 1,3-dichloro-1,1,2,2,3-pentafluoropropane, etc.

Fluoroethers: 1H,4H,4H-Perfluoro(3-oxapentane), 3-methoxy-1,1,1,2,3,3-hexafluoropropane, etc.

Fluorinated alcohols: 2,2,2-Trifluoroethanol, 2,2,3,3,3-pentafluoro-1-propanol, 1,1,1,3,3,3-hexafluoro-2-propanol, etc.

As the coating method, a batch coating method or a continuous coating method may be mentioned.

As the batch coating method, a bar coating method, a spin coating method, a screen printing method or the like may be mentioned.

As the continuous coating method, a post measurement method or a preliminary measurement method may be mentioned. The post measurement method is a method wherein an excess coating fluid is applied and later, the coating fluid is removed to bring the thickness to a prescribed level. The preliminary measurement method is a method wherein a coating fluid is applied in an amount required to obtain the predetermined thickness.

The post measurement method may, for example, be an air doctor coating method, a blade coating method, a rod coating method, a knife coating method, a squeeze coating method, an impregnation coating method or a comma coating method.

The preliminary measurement method may, for example, be a die coating method, a reverse roll coating method, a transfer roll coating method, a gravure coating method, a kiss-roll coating method, a cast coating method, a spray coating method, a curtain coating method, a calender coating method or an extrusion coating method.

As the coating method, a screen printing method or a is die coating method is preferred from such a viewpoint that a uniform polymer electrolyte membrane 12 can be formed, and a die coating method is more preferred from the viewpoint of the production efficiency.

After applying a coating fluid for an electrolyte membrane on the surface of a release substrate 42, the coating film is dried to form a polymer electrolyte membrane 12.

The drying temperature is preferably from 70 to 170° C.

After or at the same time as drying the coating film, it is preferred to carry out anneal treatment. A first catalyst layer 18 is formed on the first surface of the polymer electrolyte membrane 12 treated by annealing, whereby a membrane/electrode assembly 10 for a high output can be obtained.

The temperature for the anneal treatment is from 100 to 250° C., preferably from 130 to 220° C. The optimum temperature for the anneal treatment varies depending upon the type of the ion exchange resin constituting the polymer electrolyte membrane 12, and it is preferably a temperature higher than the glass transition temperature (Tg) of the ion exchange resin and a temperature of at most (Tg+100)° C.

The time for the anneal treatment is preferably from 5 minutes to 3 hours, more preferably from 10 minutes to 1 hour. If the time for the anneal treatment is too short, the above effects may not be obtained. On the is other hand, if the time for the anneal treatment is too long, the productivity deteriorates.

### Step (b)

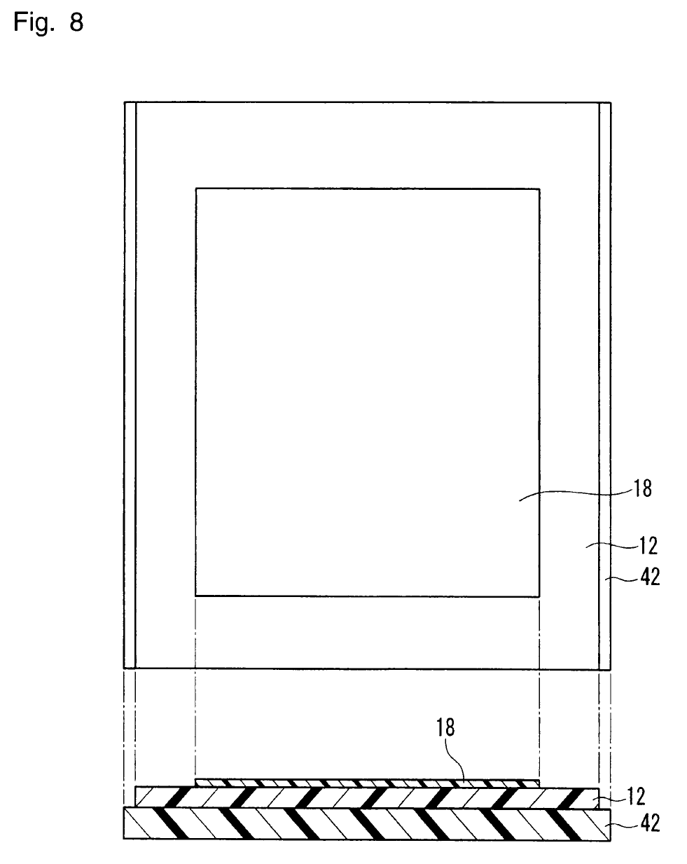

As shown in FIG. 8, at the center portion of the first surface (the main surface not in contact with the release substrate 42) of the polymer electrolyte membrane 12, a coating fluid containing a catalyst and an ion exchange resin (hereinafter referred to as the coating fluid for a first catalyst layer) is applied to form a first catalyst layer 18, leaving the periphery of the polymer electrolyte membrane 12 where the first catalyst layer is not formed.

The coating fluid for a first catalyst layer is prepared by dispersing a catalyst in a solvent and dissolving or dispersing an ion exchange resin in the solvent.

The solid content concentration of the coating fluid for a first catalyst layer is preferably from 4 to 15 mass %, more preferably from 8 to 12 mass %. When the solid content concentration of the coating fluid for a first catalyst layer is within such a range, the coating fluid for a first catalyst layer has a proper viscosity and can be uniformly applied, and no cracking is likely to form in the first catalyst layer 18 thereby formed.

In a case where the ion exchange resin is a fluororesin having ionic groups, the solvent is preferably the above-mentioned alcohol or fluorinated solvent.

The coating method is preferably a screen printing method or a die coating method from such a viewpoint that a uniform first catalyst layer 18 can be formed, and a die coating method is more preferred from the viewpoint of the production efficiency.

After applying the coating fluid for a first catalyst layer on the first surface of the polymer electrolyte membrane 12, the coating film is dried to form a first catalyst layer 18.

The drying temperature is preferably from 70 to 150° C.

### Step (c)

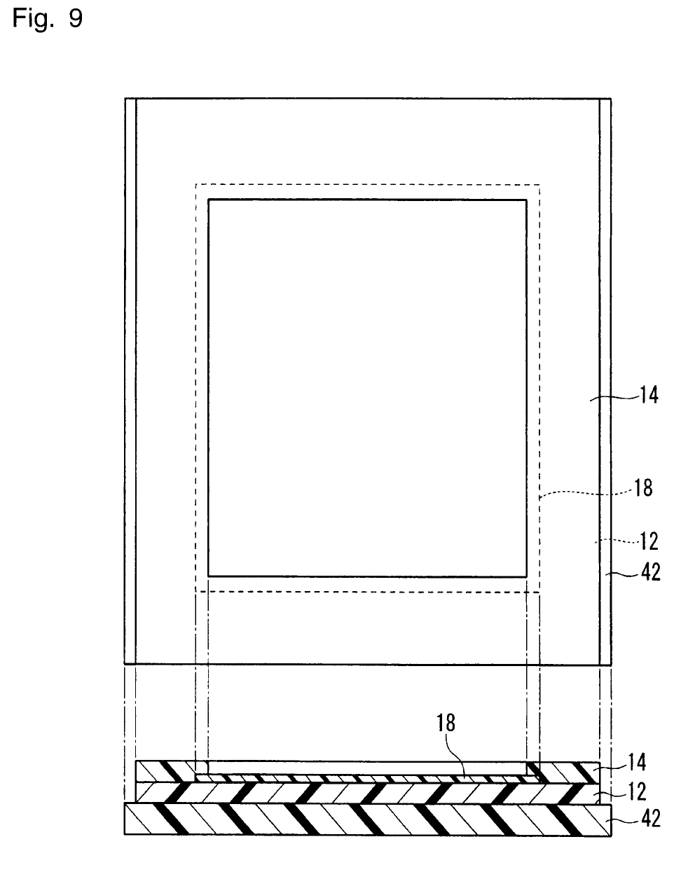

As shown in FIG. 9, the polymer electrolyte membrane 12 and the first catalyst layer 18, and the first frame 14 having an area of its opening adjusted to be smaller than the area of the first catalyst layer 18, are bonded so that the outer edge portion of the first frame 14 is in contact with the first surface of the polymer electrolyte membrane 12, and the inner edge portion of the first frame 14 is in contact with the surface of the first catalyst layer 18.

The bonding method may, for example, be a hot pressing method, a hot roll pressing method or an ultrasonic fusion method, and from the viewpoint of in-plane uniformity, a hot pressing method is preferred.

The temperature of the pressing plate in the press machine is preferably from 100 to 150° C.

The pressing pressure is preferably from 0.5 to 2.0 MPa.

### Step (d)

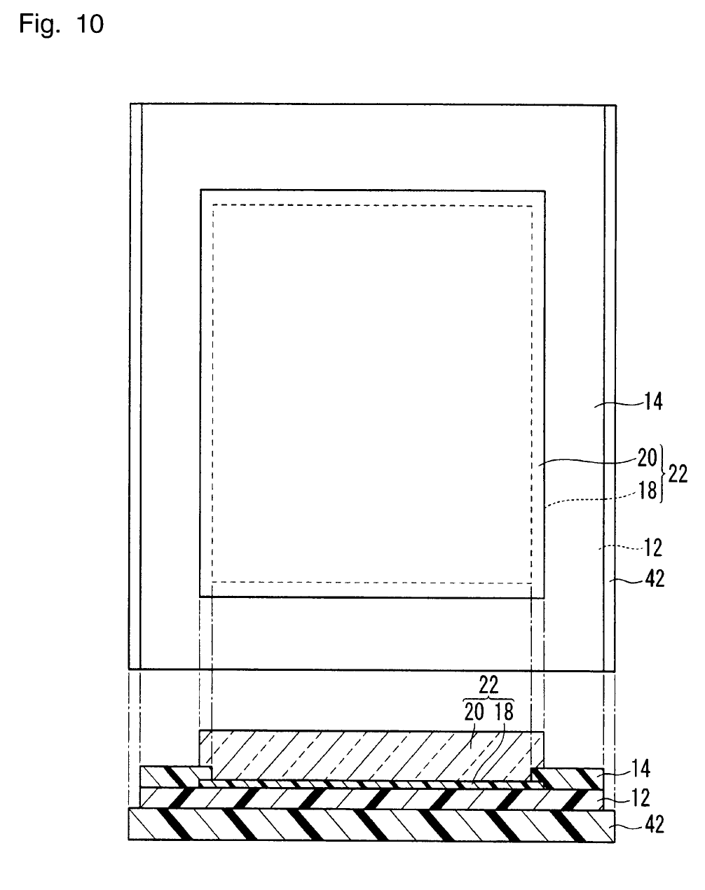

As shown in FIG. 10, the first catalyst layer 18 and the first frame 14, and the first gas diffusion layer 20 (gas diffusing substrate), are bonded, so that the first gas diffusion layer 20 is in contact with the surface of the first catalyst layer 18 and the inner edge portion of the first frame 14.

The bonding method may, for example, be a hot pressing method, a hot roll pressing method or an ultrasonic fusion method, and from the viewpoint of in-plane uniformity, a hot pressing method is preferred.

The temperature of the pressing plate in the press machine is preferably from 100 to 150° C.

The pressing pressure is preferably from 0.5 to 2.0 MPa.

### Step (e)

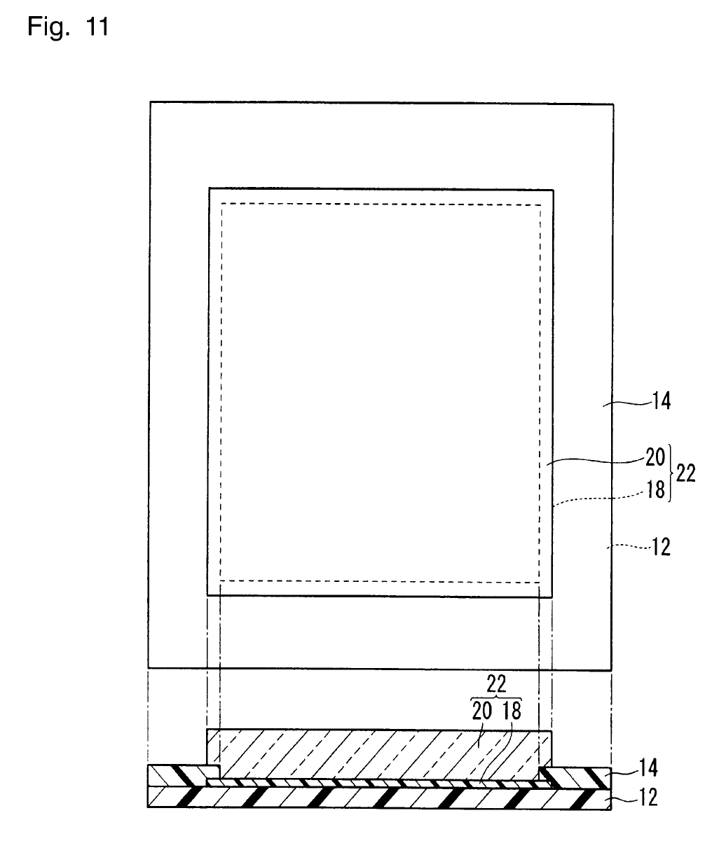

As shown in FIG. 11, the release substrate 42 is peeled from the second surface of the polymer electrolyte membrane 12.

### Step (f)

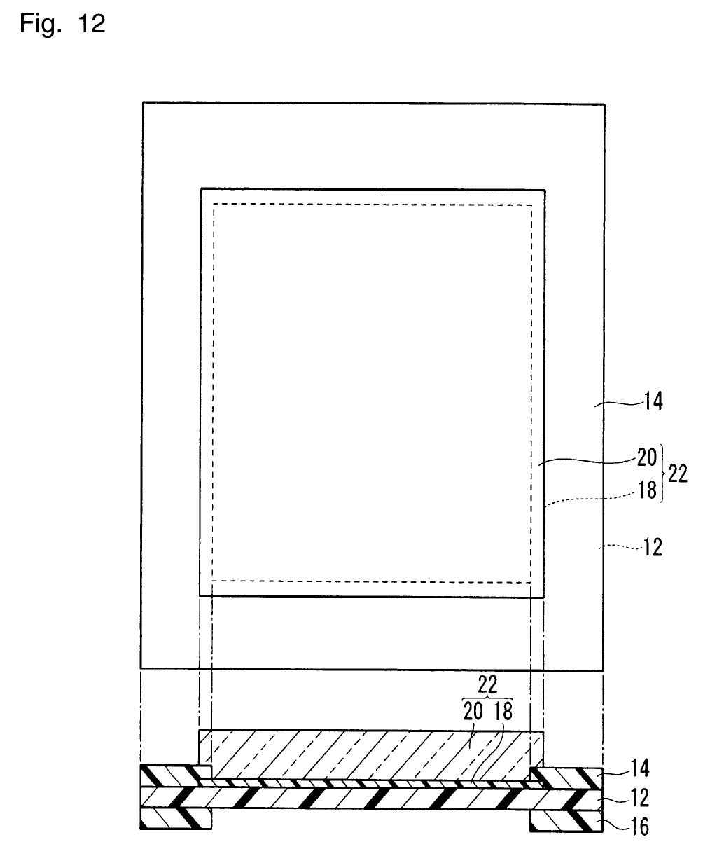

As shown in FIG. 12, the polymer electrolyte membrane 12 and the second frame 16 having an area of its opening portion adjusted to be smaller than the area of the second catalyst layer 24, are bonded, so that the second frame 16 is in contact with the second surface of the polymer electrolyte membrane 12.

The bonding method may, for example, be a hot pressing method, a hot roll pressing method or an ultrasonic fusion method, and from the viewpoint of in-plane uniformity, a hot pressing method is preferred.

The temperature of the pressing plate in the press machine is preferably from 100 to 150° C.

The pressing pressure is preferably from 0.5 to 2.0 MPa.

### Step (g)

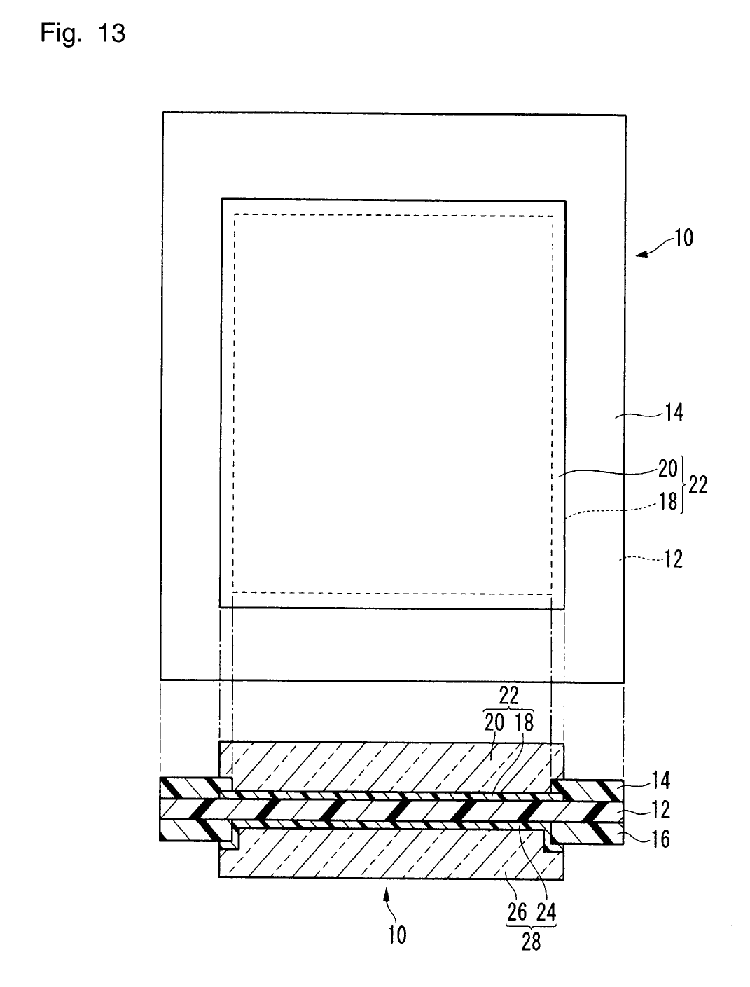

As shown in FIG. 13, the polymer electrolyte membrane 12 and the second frame 16, and the second electrode 28 preliminarily prepared, are bonded, so that the surface of the second catalyst layer 24 of the second electrode is in contact with the inner edge portion of the second frame 16 and the second surface of the polymer electrolyte membrane 12.

The bonding method may, for example, be a hot pressing method, a hot roll pressing method or an ultrasonic fusion method, and from the viewpoint of in-plane uniformity, a hot pressing method is preferred.

The temperature of the pressing plate in the press machine is preferably from 100 to 150° C.

The pressing pressure is preferably from 0.5 to 2.0 MPa.

The second electrode 28 is prepared by applying a coating fluid containing a catalyst and an ion exchange resin (hereinafter referred to as a coating fluid for a second catalyst layer) on the surface of the second gas diffusion layer 26 (gas diffusing substrate) to form a second catalyst layer 24.

The coating fluid for a second catalyst layer is prepared by dispersing a catalyst in a solvent and dissolving or dispersing an ion exchange resin in the solvent.

The solid content concentration of the coating fluid for a second catalyst layer is preferably within the same range as the solid content concentration in the coating fluid for a first catalyst layer.

As the solvent, the same one as the solvent for the coating fluid for a first catalyst layer may be mentioned.

The coating method is preferably a screen printing method or a die coating method from such a viewpoint that a uniform second catalyst layer 24 can be formed, and a die coating method is more preferred from the viewpoint of the production efficiency.

After applying the coating fluid for a second catalyst layer on the surface of the second gas diffusion layer 26, the coating film is dried to form a second catalyst layer 24.

The drying temperature is preferably from 70 to 170° C.

In the above production process, the steps (a) to (g) are carried out in this order. However, in the present invention, the order of the steps (c) to (g) is is not particularly limited, so long as the step (c) is carried out at a stage after the step (b), the step (d) is carried out at a stage after the step (c), the step (e) is carried out at a stage after the step (b), the step (f) is carried out at a stage after the step (e), and the step (g) is carried out at a stage after the step (f).

For example, after carrying out the step (c) (disposition of the first frame) and the step (d) (bonding of the first gas diffusion layer) simultaneously, the step (e) (peeling of the release substrate) may be carried out, and further the step (f) (disposition of the second frame) and the step (g) (bonding of the second electrode) may be carried out simultaneously; the step (c) (disposition of the first frame), the step (e) (peeling of the release substrate) and the step (f) (disposition of the second frame) are carried out in this order, then the step (d) (bonding of the first gas diffusion layer) and the step (g) (bonding of the second electrode) may be carried out simultaneously or separately; or after carrying out the step (e) (peeling of the release substrate), the step (c) (disposition of the first frame) and the step (f) (disposition of the second frame) may be carried out simultaneously or separately, and further the step (d) (bonding of the first gas diffusion layer) and the step (g) (bonding of the second electrode) may be carried out simultaneously is or separately.

The membrane/electrode assembly 10 to be produced by the process of the present invention is preferably such that the second electrode 28 is an anode for the following reason.

In a polymer electrolyte fuel cell, usually a gas containing hydrogen (fuel) is supplied to an anode and a gas containing oxygen (air) is supplied to a cathode. In the preparation of the second electrode 28, a part of the coating fluid for a second catalyst layer is likely to penetrate into the second gas diffusion layer 26, and a part of the second gas diffusion layer 26 is likely to be clogged. Therefore, if the second electrode 28 is used as a cathode, oxygen having a permeability lower than hydrogen is required to pass through the second gas diffusion layer 26, whereby the gas diffusion property is likely to be low. On the other hand, when the second electrode 28 is used as an anode, even at the clogged portion, hydrogen is likely to permeate relatively easily, whereby the gas diffusion property is less likely to deteriorate. Namely, the gas diffusion layer for the cathode is required to be maintained to be porous, while the gas diffusion layer of the anode may not be so porous as the cathode. Accordingly, when the second electrode 28 is used as an anode, the porosity of the cathode will be maintained, whereby a high performance polymer electrolyte fuel cell can be obtained.

In the above-described process for producing a membrane/electrode assembly of the present invention, the first catalyst layer is formed by applying a coating fluid containing a catalyst and an ion exchange resin on the first surface of the polymer electrolyte membrane, whereby the adhesion between the first catalyst layer and the polymer electrolyte membrane is excellent. Accordingly, even if the polymer electrolyte membrane undergoes swelling in a wet state and shrinkage in a dry state repeatedly, the polymer electrolyte membrane will not peel from the first catalyst layer, whereby the polymer electrolyte membrane is scarcely damaged. As a result, the durability of the membrane/electrode assembly will be improved.

Further, in the above-described process for producing a membrane/electrode assembly of the present invention, the first catalyst layer is formed on the first surface of the polymer electrolyte membrane prior to disposing the first frame at the periphery of the polymer electrolyte membrane, whereby a uniform catalyst layer is formed. As a result, a high output voltage can be obtained.

### Polymer Electrolyte Fuel Cell

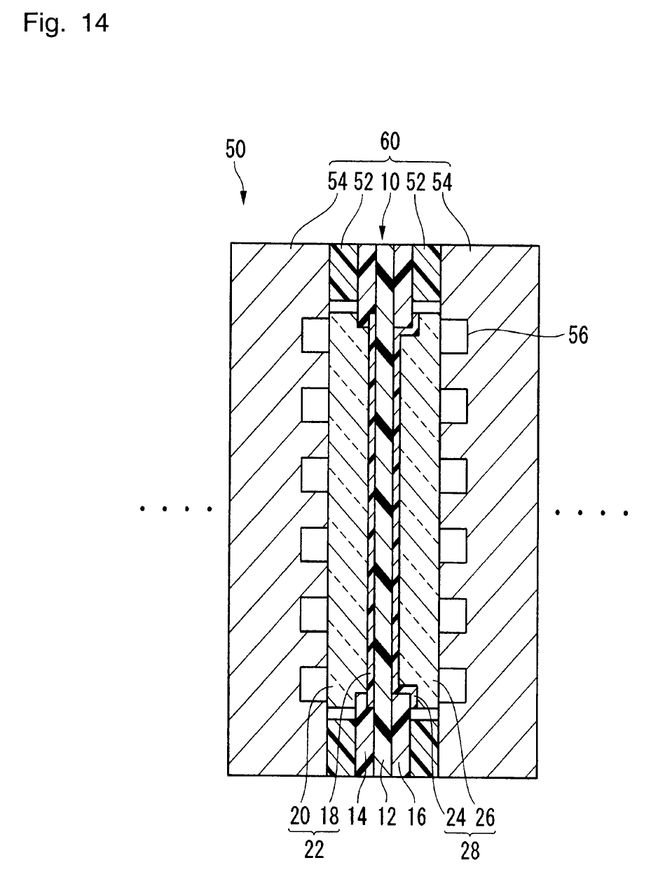

FIG. 14 is a cross-sectional view illustrating an embodiment of the polymer electrolyte fuel cell of the present invention. The polymer electrolyte fuel cell 50 is one wherein a cell 60 comprising the is membrane/electrode assembly 10, a pair of frame-shaped gas sealing materials 52 disposed to face each other, sandwiching the outer edge portions of the membrane/electrode assembly 10 and a pair of separators 54 disposed to face each other, sandwiching them, is stacked, so that the membrane/electrode assembly 10 and the separator 54 are alternately disposed.

The separator 54 is one having a plurality of grooves 56 formed on its surface to constitute gas flow paths.

As the separator 54, separators made of various electrically conductive materials may be mentioned, including a separator made of a metal, a separator made of carbon, a separator made of a material having graphite and a resin mixed, etc.

In the polymer electrolyte fuel cell, power generation is carried out by supplying a gas containing oxygen to the cathode and a gas containing hydrogen to the anode. Further, the membrane/electrode assembly of the present invention may be applied also to a methanol fuel cell whereby power generation is carried out by supplying methanol to the anode.

Now, the present invention will be described in further detail with reference to Examples, but it should be understood that the present invention is by no means restricted to such Examples.

Examples 1 to 7 are Working Examples of the present is invention, and Example 8 is a Comparative Example.

### EXAMPLE 1

### Step (a)

A copolymer (H1) (ion exchange capacity: 1.1 meq/g dry resin) comprising units based on tetrafluoroethylene and repeating units represented by the following formula (11) was dispersed in a mixed solvent of ethanol and water (ethanol/water=60/40 (mass ratio)) to prepare a coating fluid for an electrolyte membrane having a solid content concentration of 25 mass %.

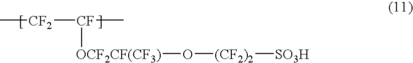

As shown in FIG. 7, on the surface of a release substrate 42 made of an ETFE film of 200 mm×200 mm×100 μm in thickness, the coating fluid for an electrolyte membrane was applied by means of a die coater so that one side of a square would be from 150 to 190 mm and a dried film thickness would be 25 μm, followed by drying for 10 minutes in a dryer at 90° C., and further anneal treatment was carried out at 140° C. for 30 minutes to form a polymer electrolyte membrane 12.

### Step (b)

The copolymer (H1) was dispersed in ethanol to prepare an ion exchange resin liquid (A) having a solid content concentration of 10 mass %.

Separately, 35 g of a catalyst (manufactured by is Tanaka Kikinzoku Kogyo K.K.) having 40 mass % of a platinum/cobalt alloy (platinum/cobalt=36/4 (mass ratio)) supported on a carbon carrier (specific surface area: 250 m²/g) was added to 222.5 g of distilled water, followed by pulverization by means of an ultrasonic application device, and further 37.5 g of ethanol was added, followed by thorough stirring to prepare a catalyst liquid (B).

To the total amount of the catalyst liquid (B), 210 g of the ion exchange resin liquid (A) was added, followed by thorough stirring to prepare a coating fluid (C) for a cathode catalyst layer having a solid content concentration of 11 mass %.

As shown in FIG. 8, at the center portion of the first surface of the polymer electrolyte membrane 12, the coating fluid (C) for a cathode catalyst layer was applied by means of a die coater so that the platinum amount would be 0.2 mg/cm², and one side of a square would be from 55 to 60 mm, followed by drying in a dryer at 90° C. for 5 minutes and further by drying in a dryer at 120° C. for 30 minutes to form a first catalyst layer 18 (cathode catalyst layer) thereby to obtain a membrane/cathode catalyst layer assembly.

### Step (c) and Step (d)

A first gas diffusion layer 20 of 56 mm×70 mm×245 μm in thickness made of carbon paper (tradename: H2315T10AC1, manufactured by NOK Corporation) (hereinafter referred to as carbon paper (P)) was is prepared.

Further, at the center portion of a PEN film of 120 mm×150 mm×25 μm in thickness, a square opening of 50 mm×50 mm was formed to prepare a first frame 14.

On an underlay made of a PTFE film having a thickness of 100 μm, the first gas diffusion layer 20, the first frame 14 and the membrane/cathode catalyst layer assembly were laminated in this order.

At that time, the first frame 14 was disposed at the periphery of the polymer electrolyte membrane 12, so that the first frame 14 was in contact with the first surface of the polymer electrolyte membrane 12 and the inner edge portion of the first frame 14 was uniformly in contact with the first catalyst layer 18.

Further, the first gas diffusion layer 20 was disposed so that the first gas diffusion layer 20 was uniformly in contact with the inner edge portion of the first frame 14 and the first gas diffusion layer 20 was in contact with the surface of the first catalyst layer 18.

The laminated one was put in a press machine preliminarily heated to 120° C. and hot-pressed for 1 minute under a pressing pressure of 1.0 MPa to form a first electrode 22 (cathode) thereby to obtain a membrane/cathode assembly.

The interior of the press machine was cooled to at most 50° C., then the pressure was released, and from the is press machine, the membrane/cathode assembly was taken out.

### Step (e)

As shown in FIG. 11, the release substrate 42 was peeled from the second surface of the polymer electrolyte membrane 12.

### Step (f) and Step (g)

33 g of a catalyst (manufactured by Tanaka Kikinzoku Kogyo K.K.) having 53 mass % of a platinum/ruthenium alloy (platinum/ruthenium=31/22 (mass ratio)) supported on a carbon carrier (specific surface area: 800 m²/g), was added to 227.5 g of distilled water, followed by pulverization by means of an ultrasonic application device, and further, 117.5 g of ethanol was added, followed by thorough stirring, to obtain a catalyst liquid (D).

To the total amount of the catalyst liquid (D), 122.5 g of the ion exchange resin liquid (A) was added, followed by thorough stirring to prepare a coating fluid (E) for an anode catalyst layer having a solid content concentration of 9 mass %.

On the surface of a second gas diffusion layer 26 made of carbon paper (P) of 56 mm×70 mm×245 μm in thickness, the coating fluid (E) for an anode catalyst layer was applied by means of a die coater so that the platinum amount would be 0.2 mg/cm², followed by drying in a dryer at 80° C. for 15 minutes to form a second is catalyst layer 24 (anode catalyst layer) thereby to prepare a second electrode 28 (anode).

Further, at the center portion of a PEN film of 120 mm×150 mm×25 μm in thickness, a square opening of 50 mm×50 mm was formed to prepare a second frame 16.

On the membrane/cathode assembly, the second frame 16 and the second electrode 28 were laminated in this order.

At that time, the second frame 16 was disposed at the periphery of the polymer electrolyte membranes 12, so that the second frame 16 was in contact with the second surface of the polymer electrolyte membrane 12.

Further, the second electrode 28 was disposed so that the surface of the second catalyst layer 24 was uniformly in contact with the inner edge portion of the second frame 16 and the surface of the second catalyst layer 24 was in contact with the second surface of the polymer electrolyte membrane 12.

The laminated one was put into a press machine preliminarily heated to 140° C. and hot-pressed for 1 minute under a pressing pressure of 1.5 MPa to obtain a membrane/electrode assembly. This membrane/electrode assembly was punched into 90 mm×110 mm so that the electrodes were located at the center to obtain the membrane/electrode assembly 10 shown in FIG. 1 (or the membrane/electrode assembly 36 shown in FIG. 4). The electrode area was 25 cm², and the minimum width W at the is portion where the frame and the gas diffusion layer overlapped, was 3 mm.

### Evaluation

The membrane/electrode assembly 10 was assembled into a power generation cell, which was operated for 12 hours under atmospheric pressure at a cell temperature of 80° C. at a current density of 0.7 A/cm² by supplying hydrogen (utilization ratio 70%)/air (utilization ratio 40%). At that time, to the anode side, humidified hydrogen at 80° C. was supplied, and to the cathode side, humidified air at 80° C. was supplied. Thereafter, the current density was changed to 0, 0.05, 0.08, 0.2, 0.3, 0.5, 0.7, 1.0 (A/cm²), and the cell voltages at current densities of 0.2, 0.7 and 1.0 (A/cm²) were measured. The results are shown in Table 1. Here, during the operation at a current density of at least 0.2 A/cm², the gas flow rates were controlled so that the utilization ratios of hydrogen and air were always constant, and at the current density of less than that level, the gas flow rates were adjusted to the utilization ratios corresponding to 0.2 A/cm².

A mixed gas comprising 80 vol % of hydrogen and 20 vol % of carbon dioxide was prepared as a simulated gas (hereinafter referred to as SRG) which is considered to be obtainable when city gas was modified.

The membrane/electrode assembly 10 was assembled into a power generation cell, which was operated for 2 is hours under atmospheric pressure at a cell temperature of 80° C. at a current density of 0.7 A/cm² by supplying SRG (utilization ratio 70%)/air (utilization ratio 40%). At that time, to the anode side, humidified SRG at 80° C. was supplied, and to the cathode side, humidified air at 80° C. was supplied. Thereafter, the current density was changed to 0, 0.05, 0.08, 0.2, 0.3, 0.5, 0.7, 1.0 (A/cm²), and the cell voltages at current densities of 0.2, 0.7 and 1.0 (A/cm²) were measured. The results are shown in Table 2. Here, during the operation at a current density of at least 0.2 A/cm², the gas flow amounts were controlled so that the utilization ratios of hydrogen and air were always constant, and at the current density of less than that level, the gas flow amounts were adjusted to the utilization ratios corresponding to 0.2 A/cm².

Further, at a rate of 50 mm/min, 90° peeling was carried out at the interface between the polymer electrolyte membrane 12 and the first catalyst layer 18, in an attempt to measure the peel strength at the interface. However, the membrane and the catalyst layer were firmly bonded and could not be peeled at the interface between the membrane and the catalyst layer.

### EXAMPLE 2

A membrane/electrode assembly 34 shown in FIG. 3 was obtained in the same manner as in Example 1 except that the membrane/cathode catalyst layer assembly obtained in the Step (b) in Example 1 was punched out in a square is shape of 70 mm×70 mm so that the first catalyst layer 18 was located at the center. The electrode area was 25 cm², and the minimum width W of the portion where the frame and the gas diffusion layer overlapped, was 3 mm.

With respect to such a membrane/electrode assembly, the cell voltage and the peel strength were measured under the same conditions as in Examples 1. The results are shown in Tables 1 to 3.

### EXAMPLE 3

### Step (a) and Step (b)

In the same manner as in Example 1, a membrane/cathode catalyst layer assembly was obtained.

### Step (c) and Step (d)

A first gas diffusion layer 20 of 56 mm×70 mm×245 μm in thickness made of carbon paper (P) was prepared.

Further, a square opening of 50 mm×50 mm was formed at the center portion of a PEN film of 120 mm×150 mm×25 μm in thickness, to prepare a first frame 14.

Further, the membrane/cathode catalyst layer assembly was punched out in a square shape of 70 mm×70 mm so that the first catalyst layer 18 was located at the center.

Further, at the center portion of a PEN film of 150 mm×150 mm×50 μm in thickness, a square opening of 70 mm×70 mm was formed to prepare a spacer 30.

On an underlay made of a PTFE film having a thickness of 100 μm, the first gas diffusion layer 20, is the first frame 14 and the membrane/cathode catalyst layer assembly were laminated in this order. Further, the spacer 30 was disposed at the periphery of the membrane/cathode catalyst layer assembly.

At that time, the first frame 14 was disposed at the periphery of the polymer electrolyte membrane 12, so that the first frame 14 was in contact with the first surface of the polymer electrolyte membrane 12, and the inner edge portion of the first frame 14 was uniformly in contact with the first catalyst layer 18.

Further, the first gas diffusion layer 20 was disposed, so that the first gas diffusion layer 20 was uniformly in contact with the inner edge portion of the first frame 14, and the first gas diffusion layer 20 was in contact with the surface of the first catalyst layer 18.

The laminated one was put into a press machine preliminarily heated to 120° C. and hot-pressed for 1 minute under a pressing pressure of 1.0 MPa to form a first electrode 22 (cathode), thereby to obtain a membrane/cathode assembly.

The interior of the press machine was cooled to at most 50° C., then the pressure was released, and the membrane/cathode assembly was taken out from the press machine.

### Step (e) to Step (g)

Thereafter, in the same manner as in Example 1, the membrane/electrode assembly 32 shown in FIG. 2 was obtained. The electrode area was 25 cm², and the minimum width W of the portion where the frame and the gas diffusion layer overlapped, was 3 mm.

With respect to such a membrane/electrode assembly, the cell voltage was measured under the same conditions as in Example 1. The peel strength could not be measured like in Example 1. The results are shown in Tables 1 and 2.

### EXAMPLE 4

A membrane/electrode assembly 40 shown in FIG. 6 was obtained in the same manner as in Example 1 except that the opening of the second frame 16 was changed to a square-shape of 51 mm×51 mm. The electrode area was 25 cm², and the width W of the portion where the frame and the gas diffusion layer overlapped, was 3 mm and 2.5 mm.

With respect to such a membrane/electrode assembly, the cell voltage was measured under the same conditions as in Example 1. The peel strength could not be measured like in Example 1. The results are shown in Tables 1 and 2.

### EXAMPLE 5

A membrane/electrode assembly 38 shown in FIG. 5 was obtained in the same manner as in Example 1 except that the opening of the first frame 14 was changed to a square-shape of 51 mm×51 mm. The electrode area was 25 cm², and the width W of the portion where the frame and is the gas diffusion layer overlapped, was 2.5 mm and 3 mm.

With respect to such a membrane/electrode assembly, the cell voltage was measured under the same conditions as in Example 1. The peel strength could not be measured like in Example 1. The results are shown in Tables 1 and 2.

### EXAMPLE 6

### Step (a) and Step (b)

In the same manner as in Example 1, a membrane/cathode catalyst layer assembly was obtained.

### Step (c) and Step (d)

180 g of distilled water was added to 20 g of gas phase-grown carbon fiber (tradename: VGCF-H, manufactured by Showa Denko K.K., fiber diameter: about 150 nm, fiber length: 10 to 20 μm), followed by thorough stirring. 200 g of an ion exchange resin solution (A) was added thereto, followed by thorough stirring, and further, mixing and pulverization were carried out by means of a homogenizer to prepare a coating fluid (F) for a cathode carbon layer.

On the surface of the first gas diffusion layer 20 made of carbon paper (P) of 56 mm×70 mm×245 μm in thickness, the coating fluid (F) for a cathode carbon layer was applied by means of a die coater so that the solid content amount would be 0.8 mg/cm² and dried in a dryer at 80° C. for 15 minutes to form a carbon layer (not shown) thereby to prepare a gas diffusion layer (Q) for a cathode.

Further, at the center portion of a PEN film of 120 mm×150 mm×25 μm in thickness, a square opening of 50 mm×50 mm was formed to prepare a first frame 14.

On an underlay made of a PTFE film having a thickness of 100 μm, the gas diffusion layer (Q) for a cathode, the first frame 14 and the membrane/cathode catalyst layer assembly were laminated in this order.

At that time, the first frame 14 was disposed at the periphery of the polymer electrolyte membrane 12, so that the first frame 14 was in contact with the first surface of the polymer electrolyte membrane 12, and the inner edge portion of the first frame 14 was uniformly in contact with the first catalyst layer 18.

Further, the gas diffusion layer (Q) for a cathode was disposed, so that the carbon layer (not shown) of the gas diffusion layer (Q) for a cathode was uniformly in contact with the inner edge portion of the first frame 14, and the carbon layer is in contact with the surface of the first catalyst layer 18.

The laminated one was put into a press machine preliminarily heated to 120° C. and hot-pressed for 1 minute under a pressing pressure of 1.0 MPa, to form a first electrode 22 (cathode) provided with a carbon layer (not shown) thereby to obtain a membrane/cathode assembly.

The interior of the press machine was cooled to at most 50° C., then the pressure was released, and the membrane/cathode assembly was taken out from the press is machine.

### Step (e)

As shown in FIG. 11, the release substrate 42 was peeled from the second surface of the polymer electrolyte membrane 12.

### Step (f) and Step (g)

27 g of ethanol and 135 g of distilled water were added to 20 g of gas phase-grown carbon fiber (tradename: VGCF-H manufactured by Showa Denko K.K., fiber diameter: about 150 nm, fiber length: 10 to 20 μm), followed by thorough stirring. Then, 140 g of the ion exchange resin liquid (A) was added thereto, followed by thorough stirring, and further mixing and pulverization were carried out by means of a homogenizer to prepare a coating fluid (G) for an anode carbon layer.

On the surface of the second gas diffusion layer 26 made of carbon paper (P) of 56 mm×70 mm×245 μm in thickness, the coating fluid (G) for an anode carbon layer was applied by means of a die coater so that the solid content amount would be 0.8 mg/cm², and dried in a dryer at 80° C. for 15 minutes to form a carbon layer (not shown) thereby to prepare a gas diffusion layer (R) for an anode.

On the surface of the carbon layer of the gas diffusion layer (R) for an anode, the coating fluid (E) for an anode catalyst layer was applied by means of a die coater so that the platinum amount would be 0.2 mg/cm², is and dried in a dryer at 80° C. for 15 minutes to form a second catalyst layer 24 (anode catalyst layer) thereby to prepare the second electrode 28 (anode) provided with a carbon layer (not shown).

Further, at the center portion of a PEN film of 120 mm×150 mm×25 μm in thickness, a square opening of 50 mm×50 mm was formed to prepare a second frame 16.

On the membrane/cathode assembly, the second frame 16 and the second electrode 28 were laminated in this order.

At that time, the second frame 16 was disposed at the periphery of the polymer electrolyte membrane 12, so that the second frame 16 was in contact with the second surface of the polymer electrolyte membrane 12.

Further, the second electrode 28 was disposed, so that the surface of the second catalyst layer 24 was uniformly in contact with the inner edge portion of the second frame 16, and the surface of the second catalyst layer 24 was in contact with the second surface of the polymer electrolyte membrane 12.

The laminated one was put in a press machine preliminarily heated to 140° C. and hot-pressed for 1 minute under a pressing pressure of 1.5 MPa to obtain a membrane/electrode assembly. Such a membrane/electrode assembly was punched in a size of 90 mm×110 mm so that the electrodes were located at the center to obtain a membrane/electrode assembly 10 provided with a carbon is layer (not shown) (or the membrane/electrode assembly 36 provided with a carbon layer (not shown), as shown in FIG. 4). The electrode area was 25 cm², and the minimum width W of the portion where the frame and the gas diffusion layer overlapped, was 3 mm.

With respect to such a membrane/electrode assembly, the cell voltage was measured under the same conditions as in Example 1. The peel strength could not be measured like in Example 1. The results re shown in Tables 1 and 2.

### EXAMPLE 7

### Step (a)

In the same manner as in Example 1, a polymer electrolyte membrane 12 was formed on the surface of a release substrate 42.

### Step (b)

As shown in FIG. 8, at the center portion of the first surface of the polymer electrolyte membrane 12, the coating fluid (E) for an anode catalyst layer was applied by means of a die coater so that the platinum amount would be 0.2 mg/cm² and one side of a square-shape would be from 55 to 70 mm and dried in a dryer at 90° C. for 5 minutes and further dried in a dryer at 120° C. for 30 minutes to form a first catalyst layer 18 (anode catalyst layer) thereby to obtain an membrane/anode catalyst layer assembly.

### Step (c) and Step (d)

In the same manner as in Example 6, a gas diffusion layer (R) for an anode was prepared.

Further, at the center portion of a PEN film of 120 mm×150 mm×25 μm in thickness, a square opening of 50 mm×50 mm was formed to prepare a first frame 14.

On an underlay made of a PTFE film having a thickness of 100 μm, the gas diffusion layer (R) for an anode, the first frame 14 and the membrane/anode catalyst layer assembly were laminated in this order.

At that time, the first frame 14 was disposed at the periphery of the polymer electrolyte membrane 12, so that the first frame 14 was in contact with the first surface of the polymer electrolyte membrane 12, and the inner edge portion of the first frame 14 was uniformly in contact with the first catalyst layer 18.

Further, the gas diffusion layer (R) for an anode was disposed so that the carbon layer (not shown) of the gas diffusion layer (R) for an anode was uniformly in contact with the inner edge portion of the first frame 14, and the carbon layer was in contact with the surface of the first catalyst layer 18.

The laminated one was put into a press machine preliminarily heated to 120° C. and hot-pressed for 1 minute under a pressing pressure of 1.0 MPa to form a first electrode 22 (anode) thereby to obtain a membrane/anode assembly.

The interior of the press machine was cooled to at is most 50° C., then the pressure was released, and the membrane/anode assembly was taken out from the press machine.

### Step (e)

As shown in FIG. 11, the release substrate 42 was peeled from the second surface of the polymer electrolyte membrane 12.

### Step (f) and Step (g)

25 g of a catalyst (manufactured by Tanaka Kinzoku Kogyo K.K.) having 40 mass % of a platinum/cobalt alloy (platinum/cobalt=36/4 (mass ratio)) supported on a carbon carrier (specific surface area: 250 m²/g) was added to 322 g of distilled water and pulverized by means of an ultrasonic application device, and further, 3 g of ethanol was added, followed by thorough stirring to prepare a catalyst liquid (B2).

To the total amount of the catalyst liquid (B2), 150 g of the ion exchange resin liquid (A) was added, followed by thorough stirring to prepare a coating fluid (C2) for a cathode catalyst layer having a solid content concentration of 8 mass %.

Further, in the same manner as in Example 6, a gas diffusion layer (Q) for a cathode was prepared.

On the surface of the carbon layer of the gas diffusion layer (Q) for a cathode, the coating fluid (C2) for a cathode catalyst layer was applied by means of a die coater so that the platinum amount would be 0.2 mg/cm² and dried for 15 minutes in a dryer at 80° C. to form a second catalyst layer 24 (cathode catalyst layer) thereby to prepare a second electrode 28 (cathode) provided with a carbon layer (not shown).

Further, at the center portion of a PEN film of 120 mm×150 mm×25 μm in thickness, a square opening of 50 mm×50 mm was formed to prepare a second frame 16.

On the membrane/anode assembly, the second frame 16 and the second electrode 28 were laminated in this order.

At that time, the second frame 16 was disposed at the periphery of the polymer electrolyte membrane 12 so that the second frame 16 was in contact with the second surface of the polymer electrolyte membrane 12.

Further, the second electrode 28 was disposed so that the surface of the second catalyst layer 24 was uniformly in contact with the inner edge portion of the second frame 16, and the surface of the second catalyst layer 24 was in contact with the second surface of the polymer electrolyte membrane 12.

The laminated one was put into a press machine preliminarily heated to 140° C. and hot-pressed for 1 minute under a pressing pressure of 1.5 MPa to obtain a membrane/electrode assembly. Such a membrane/electrode assembly was punched in a size of 90 mm×110 mm so that the electrodes are located at the center to obtain a membrane/electrode assembly 10 provided with a carbon layer (not shown) as shown in FIG. 1 (or a is membrane/electrode assembly 36 provided with a carbon layer (not shown), as shown in FIG. 4). The electrode area was 25 cm², and the minimum width W of the portion where the frame and the gas diffusion layer overlapped, was 3 mm.

With respect to the membrane/electrode assembly, the cell voltage was measured under the same conditions as in Example 1. The peel strength could not be measured like in Example 1. The results are shown in Tables 1 and 2.

### EXAMPLE 8

A membrane/electrode assembly was obtained in the same manner as in Example 1 except that the second frame 16 was not disposed. However, since the frame was provided on one side only, the periphery of the polymer electrolyte membrane curled, and it was not possible to handle it under a stabilized condition.

TABLE 1

| | Cell voltage (V) | | |
|---|---|---|---|
| Fuel = hydrogen | 0.2 A/cm² | 0.7 A/cm² | 1.0 A/cm² |
| Example 1 | 0.76 | 0.62 | 0.52 |
| Example 2 | 0.76 | 0.62 | 0.52 |
| Example 3 | 0.76 | 0.62 | 0.52 |
| Example 4 | 0.76 | 0.62 | 0.52 |
| Example 5 | 0.76 | 0.62 | 0.52 |
| Example 6 | 0.77 | 0.65 | 0.54 |
| Example 7 | 0.75 | 0.63 | 0.52 |

TABLE 2

| | Cell voltage (V) | | |
|---|---|---|---|
| Fuel = SRG | 0.2 A/cm² | 0.7 A/cm² | 1.0 A/cm² |
| Example 1 | 0.74 | 0.57 | 0.44 |
| Example 2 | 0.74 | 0.57 | 0.44 |
| Example 3 | 0.74 | 0.57 | 0.44 |
| Example 4 | 0.74 | 0.57 | 0.44 |
| Example 5 | 0.74 | 0.57 | 0.44 |
| Example 6 | 0.76 | 0.63 | 0.50 |
| Example 7 | 0.74 | 0.60 | 0.49 |

A cell employing the membrane/electrode assembly of the present invention provided a high output voltage in each of a low current density region and a high current density region. Further, it was possible to carry out power generation constantly without leakage of a gas from the membrane/electrode assembly.

The membrane/electrode assembly of the present invention is very useful for a polymer electrolyte fuel cell to be used for e.g. a power source for a mobile such as an automobile, a distributed power generation system or a household cogeneration system.

The entire disclosure of Japanese Patent Application No. 2008-034625 filed on Feb. 15, 2008 including specification, claims, drawings and summary is incorporated herein by reference in its entirety.

What is claimed is:

1. A membrane/electrode assembly for a polymer electrolyte fuel cell, comprising:
a polymer electrolyte membrane containing an ion exchange resin;
a first frame disposed at the periphery of the polymer electrolyte membrane so that at least a part thereof is in contact with a first surface of the polymer electrolyte membrane;
a second frame disposed at the periphery of the polymer electrolyte membrane so that at least a part thereof is in contact with a second surface of the polymer electrolyte membrane;
a first electrode having a first catalyst layer is containing a catalyst and an ion exchange resin, and a first gas diffusion layer, wherein the first catalyst layer is in contact with the first surface of the polymer electrolyte membrane; and
a second electrode having a second catalyst layer containing a catalyst and an ion exchange resin, and a second gas diffusion layer, wherein the second catalyst layer is in contact with the second surface of the polymer electrolyte membrane;
wherein the inner edge portion of the first frame is located between the first catalyst layer and the first gas diffusion layer; and
the inner edge portion of the second frame is located between the polymer electrolyte membrane and the second catalyst layer.

2. A process for producing a membrane/electrode assembly for a polymer electrolyte fuel cell, comprising:
a polymer electrolyte membrane containing an ion exchange resin;
a first frame disposed at the periphery of the polymer electrolyte membrane so that at least a part thereof is in contact with a first surface of the polymer electrolyte membrane;
a second frame disposed at the periphery of the polymer electrolyte membrane so that at least a part thereof is in contact with a second surface of the polymer electrolyte membrane;
a first electrode having a first catalyst layer containing a catalyst and an ion exchange resin, and a first gas diffusion layer, wherein the first catalyst layer is in contact with the first surface of the polymer electrolyte membrane; and
a second electrode having a second catalyst layer containing a catalyst and an ion exchange resin, and a second gas diffusion layer, wherein the second catalyst layer is in contact with the second surface of the polymer electrolyte membrane;
wherein the inner edge portion of the first frame is located between the first catalyst layer and the first gas diffusion layer; and
the inner edge portion of the second frame is located between the polymer electrolyte membrane and the second catalyst layer;
said process comprising forming the first catalyst layer on the first surface of the polymer electrolyte membrane by applying a coating fluid containing a catalyst and an ion exchange resin, and then disposing the first frame at the periphery of the polymer electrolyte membrane.

3. The process for producing a membrane/electrode assembly for a polymer electrolyte fuel cell according to claim 2, which comprises the following steps (b) to (d), (f) and (g):
(b) a step of forming the first catalyst layer by applying a coating fluid containing a catalyst and an ion exchange resin on the first surface of the polymer electrolyte membrane;
(c) a step of bonding, at a stage after the step (b), the polymer electrolyte membrane and the first catalyst layer, and the first frame, so that at least a part of the first frame is in contact with the first surface of the polymer electrolyte membrane, and the inner edge portion of the first frame is in contact with the surface of the first catalyst layer;
(d) a step of bonding, at the same time as the step (c) or at a stage after the step (c), the first catalyst layer and the first frame, and the first gas diffusion layer, so that the first gas diffusion layer is in contact with the surface of the first catalyst layer and the inner edge portion of the first frame;
(f) a step of bonding, at a stage after the step (b) the polymer electrolyte membrane and the second frame, so that at least a part of the second frame is in contact with the second surface of the polymer electrolyte membrane; and
(g) a step of bonding, at the same time as the step (f) or at a stage after the step (f), the polymer electrolyte membrane and the second frame, and the second electrode, so that the surface of the second catalyst layer of the second electrode is in contact with the inner edge portion of the second frame and the second is surface of the polymer electrolyte membrane.

4. The process for producing a membrane/electrode assembly for a polymer electrolyte fuel cell according to claim 3, which further includes the following steps (a) and (e):
(a) a step of forming the polymer electrolyte membrane by apply a coating fluid containing an ion exchange resin on the surface of a release substrate; and
(e) a step of peeling the release substrate from the second surface of the polymer electrolyte membrane at a stage after the step (b) and before the step (f).

5. The process for producing a membrane/electrode assembly for a polymer electrolyte fuel cell according to claim 4, wherein in the step (a), after applying the coating fluid on the release substrate, anneal treatment is carried out at a temperature of from 100 to 250° C.

6. The process for producing a membrane/electrode assembly for a polymer electrolyte fuel cell according to claim 4, wherein the steps (a), (b), (c), (d), (e), (f) and (g) are carried out in this order; or the steps (a) and (b) are carried out in this order, then the steps (c) and (d) are carried out simultaneously, then the step (e) is carried out, and then the steps (f) and (g) are carried out simultaneously.

7. The process for producing a membrane/electrode assembly for a polymer electrolyte fuel cell according to claim 5, wherein the steps (a), (b), (c), (d), (e), (f) and (g) are carried out in this order; or the steps (a) and (b) are carried out in this order, then the steps (c) and (d) are carried out simultaneously, then the step (e) is carried out, and then the steps (f) and (g) are carried out simultaneously.

8. The process for producing a membrane/electrode assembly for a polymer electrolyte fuel cell according to claim 3, wherein the bonding in each of the steps (c), (d), (f) and (g) is carried out by a hot pressing method.

9. The process for producing a membrane/electrode assembly for a polymer electrolyte fuel cell according to claim 4, wherein the bonding in each of the steps (c), (d), (f) and (g) is carried out by a hot pressing method.

10. The process for producing a membrane/electrode assembly for a polymer electrolyte fuel cell according to claim 5, wherein the bonding in each of the steps (c), (d), (f) and (g) is carried out by a hot pressing method.

11. The process for producing a membrane/electrode assembly for a polymer electrolyte fuel cell according to claim 6, wherein the bonding in each of the steps (c), (d), (f) and (g) is carried out by a hot pressing method.

12. The process for producing a membrane/electrode assembly for a polymer electrolyte fuel cell according to claim 7, wherein the bonding in each of the steps (c), (d), (f) and (g) is carried out by a hot pressing method.
